(19) United States
(12) Patent Application Publication
(10) Pub. No.: US 2016/0004264 A1
(43) Pub. Date: Jan. 7, 2016

(54) THERMAL BALANCING VALVE AND SYSTEM USING THE SAME

(71) Applicant: Energx Controls, Inc., Cypress, CA (US)

(72) Inventors: Luther Jerry Watts, Winnetka, CA (US); Timothy Dale Krause, Cypress, CA (US)

(21) Appl. No.: 14/789,878

(22) Filed: Jul. 1, 2015

Related U.S. Application Data
(60) Provisional application No. 62/020,792, filed on Jul. 3, 2014.

(51) Int. Cl. G05D 23/02

(52) U.S. Cl. CPC G05D 23/022; G05D 23/025

(57) ABSTRACT

A thermal valve having a sealed expansion chamber containing heat-sensitive material that expands or contracts based on a fluid temperature flowing through the valve, which operates a rod/piston to close or open a valve.

### CROSS-REFERENCE TO RELATED APPLICATION(S)

This non-provisional patent application claims the priority to and the benefit of U.S. Provisional Application Ser. No. 62/020,792, filed Jul. 3, 2014, and entitled Thermal Balancing Valve and System Using the Same, the entire contents of which is incorporated herein by reference.

### BACKGROUND

1. Field

The present invention relates to the field of hot water systems and heating systems for domestic and industrial use.

2. Description of Related Art

Hot water supply systems and hydronic heating systems generally include a number of regions and/or zones that supply hot water to different parts of a building or facility. Typically, the flow of water through each of these regions/zones is adjusted and balanced at an initial point in time (e.g., when the system becomes operational) under a particular set of operational conditions and is often not rebalanced during the life of the system. However, as operating conditions change, a system often drifts from its balanced position. For example, as the seasons change, a particular region/zone in the system may lose more or less heat than other regions/zones, which may require more or less hot water to flow to that particular zone than initially allotted. Further, changes or repairs made to the system, or even the building construction, can lead to the system becoming out of balance.

Furthermore, by maintaining a relatively constant flow of water through the system irrespective of hot water temperatures in the various regions/zones, the recirculation pump and the boiler in the hot water or hydronic heating system may perform more work or operate for longer periods of time than optimally required, which can lead to a significant waste of energy.

### SUMMARY

Aspects of embodiments of the present invention are directed toward a thermal valve for balancing the temperature of a recirculating hot water supply system or a hydronic heating system by controlling the flow of fluid through the system.

Aspects of embodiments of the present invention are directed to a thermal valve (e.g., a thermal balance valve) having an actuator (e.g., a sealed expansion chamber or capsule) containing a heat-sensitive material (e.g., wax) that expands or contracts based on a fluid temperature. The actuator operates a rod/piston to close or open the valve. The thermal valve closes in response to increasing temperature. By placing the thermal valve in a circulation path of fluid in a hot water supply system or a hydronic heating system, the thermal valve may regulate (e.g., passively regulate) the flow of fluid flow through the path based on the temperature of the fluid. As such, a hot water supply system or a hydronic heating system may maintain a substantially constant temperature by utilizing one or more thermal valves to passively control the flow of circulating fluid. Further, by utilizing one or more thermal valves in a hot water supply system or a hydronic heating system having a number of fluid circulation loops and/or zones, the system may automatically and passively maintain balance over time. The passive balancing of the system may occur in lieu of or in the presence of manual balancing adjustments to the system. Additionally, the use of the thermal valve(s) to restrict the flow of hot water at appropriate points during the operation of the hot water supply or hydronic heating system may lead to substantial energy and cost savings.

### BRIEF DESCRIPTION OF THE DRAWINGS

The accompanying drawings, together with the specification, illustrate exemplary embodiments of the present invention, and, together with the description, serve to explain aspects of embodiments of the present invention. In the drawings, like reference numerals are used throughout the figures to reference like features and components. The figures are not necessarily drawn to scale. The above and other features and aspects of the present invention will become more apparent by the following detailed description of illustrative embodiments thereof with reference to the attached drawings, in which:

FIGS. 1A and 1B illustrate a thermal valve, according to an illustrative embodiment of the present invention; FIG. 1A is a vertical sectional view showing the interior of the thermal valve, according to an illustrative embodiment of the present invention; FIG. 1B is a side view of the exterior of the thermal valve, according to an illustrative embodiment of the present invention.

FIG. 2 illustrates a joint assembly integrated with a thermal valve, according to an embodiment of the present invention;

FIG. 3 is a schematic diagram of a hot water supply system including the thermal valve, according to an embodiment of the present invention; and

FIG. 4 is a schematic diagram of a hydronic heating system including the thermal valve, according to an embodiment of the present invention.

### DETAILED DESCRIPTION

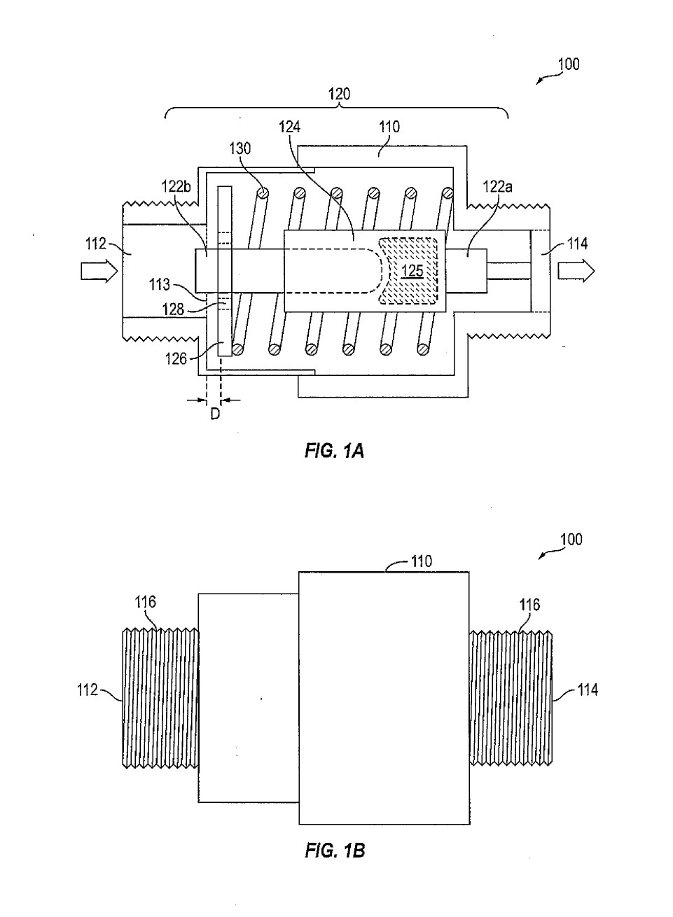

FIGS. 1A and 1B illustrate a thermal valve 100, according to an embodiment of the present invention. FIG. 1A is a cutaway view of the interior of the thermal valve 100, according to an illustrative embodiment of the present invention. FIG. 1B is a side view of the exterior of the thermal valve 100, according to an illustrative embodiment of the present invention.

Referring to FIG. 1A, the thermal valve (e.g., thermal balance valve) 100 includes a housing 110 and a power unit 120 inside the housing 110. The housing 110 includes an inlet 112 and an outlet 114 for permitting the flow of a fluid (e.g., water) through the interior of the housing 110. The housing 110 may be coupled to a conduit of a fluid circulation system via, for example, a screw mechanism or threaded joint. In an embodiment, the power unit 120 is coupled to (e.g., fixedly coupled to) the housing 110 on one end through a first rod (e.g., a shaft) 122a, and coupled to (e.g., operatively coupled to) the housing 110 on another end via a second rod (e.g., a shaft or piston) 122b and a flow control disk 126 fixedly attached to the second rod 122b.

A compressive element (e.g., a spring) 130 couples the flow control disk 126 to the interior of the housing 110 and maintains the flow control disk 126 at a default position. The flow control disk 126 has a diameter that is larger than a diameter of the inlet opening 113 to stop or reduce the flow of fluid through the housing 110 when pressed against the inlet opening 113.

In an embodiment, the flow control disk 126 is maintained in a default position, which is at least at a distance D from the inlet opening 113. Thus, when in the default position, a gap exists between the flow control disk 126 and the inlet opening 113 allowing fluid to pass through the thermal valve 100. The compressive element 130 allows the flow control disk 126 to move relative to the inlet opening 133 in response to pressure changes in the inflow of fluid. Thus, the thermal valve 100 may accommodate higher fluid pressure by increasing the gap D and permitting a greater flow of fluid through the thermal valve 100, and may accommodate lower fluid pressure by decreasing the gap D and reducing the flow of fluid.

According to an embodiment, the actuator 124 contains heat-sensitive material (e.g., a wax pellet) 125. As the temperature of the fluid surrounding the actuator 124 increases, the heat-sensitive material 125 undergoes a solid to liquid transition, which is accompanied by an increase in volume of the heat-sensitive material 125. The expansion of the heat-sensitive material pushes the second rod (e.g., piston) 122b in a direction away from the first rod 122a, thus driving the flow control disk 126 toward the inlet opening 133 and reducing the fluid flow through the inlet 112. At a predetermined temperature, the heat-sensitive material 125 expands to a point that the flow control disk 126 is fully pressed against the inlet opening 113, thus sealing the opening 113 and stemming the flow of fluid through the thermal valve (and thereby completely shutting off the valve). In one example, the actuator 124 may include thermally conductive materials such as brass to make the thermal valve 100 more responsive (e.g., more sensitive) to fluid temperature changes.

The heat-sensitive material 125 may include refined hydrocarbons, vegetable matter extracts, metal particles, synthetic polymers, and/or the like. In one example. The heat-sensitive material 125 may include paraffin wax. The composition of the heat-sensitive material 125 may be chosen such that the heat-sensitive material 125 actuates the flow control disk 126 to close the thermal valve 100 at a desired temperature. In one example, the closing temperature may be about 105° F. or about 110° F. In other examples, the closing temperature may in a range between about 120° F. and about 200° F.

In one embodiment, the flow control disk 126 includes one or more bypass holes 128 to provide a small fluid bypass path even when the thermal valve 100 is closed.

Referring to FIG. 1B, the ends of the inlet 112 and outlet 114 may be threaded to couple to threaded pipes of the circulation conduit. In one example tapered threats (such as those conforming to the national pipe thread taper (NPT)) may be used to form a seal when the inlet 112 and outlet 114 are coupled to the circulation conduit.

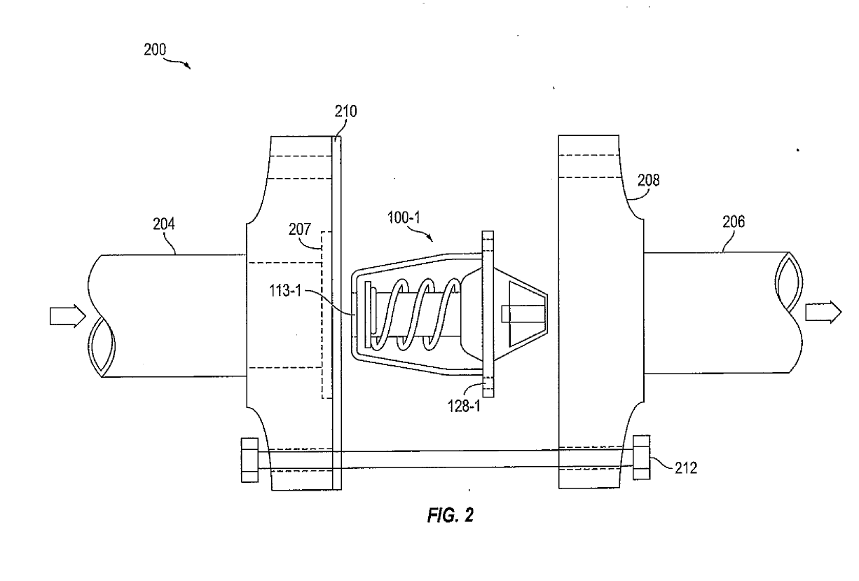

FIG. 2 illustrates a joint assembly 200 integrated with a thermal valve 100-1, according to an embodiment of the present invention.

In one embodiment, the joint assembly 200 includes an inlet pipe 202 and an outlet pipe 204, a pair of flanges 208 coupled to the inlet and outlet pipes 204 and 206, a rubber gasket 210 between the pair of flanges 208 and creating a sealed chamber within which the thermal valve 100-1 is integrated. The flanges 208 and the rubber gasket may be held together in compression by a fastening mechanism 212, which may include two or more nuts and bolts. The thermal valve 100-1 may be similar in structure to the thermal valve 100 described above with respect to FIGS. 1A and 1B. The thermal valve 100-1 may fit within one or more grooves 207 within one or more of the flanges 208. The diameter of the inlet opening 113-1 of the thermal valve 100-1 may be smaller than the diameter of the inlet pipe 204. For example, the inlet pipe may be a standard 1 inch pipe, while the inlet opening may be ⅞ inch wide.

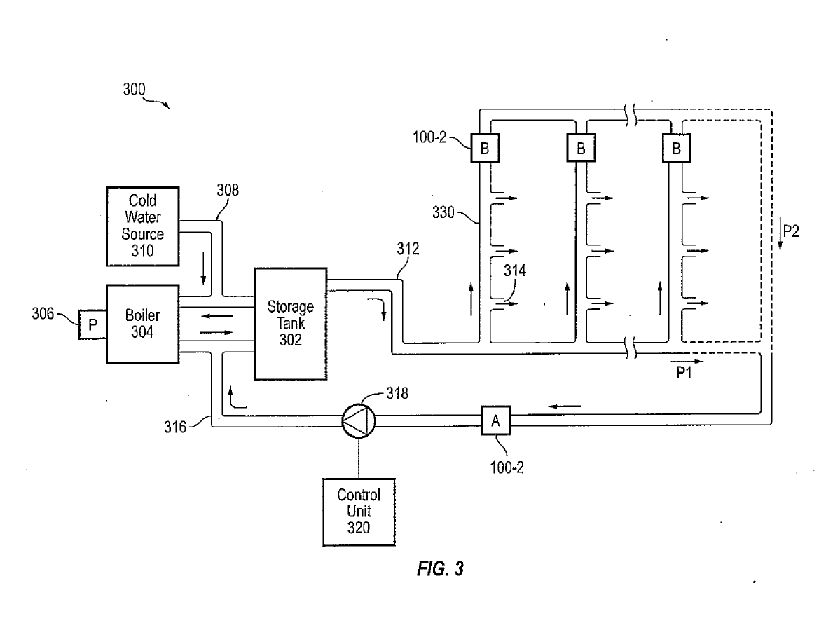

FIG. 3 is a schematic diagram of a hot water supply system 300 including the thermal valve 100-2, according to an illustrative embodiment of the present invention.

According to an embodiment, the hot water supply system (e.g., a domestic/recirculating hot water supply system) 300 includes a storage tank 302, a boiler (e.g., water heater) 304, an aquastat 306 for controlling and maintaining the water temperature at the boiler 304 and/or storage tank 302, a cold water conduit 308 for providing cold water to the recirculation system from a cold water source 310, a supply conduit 312 for supplying hot water to one or more water outlets (e.g., taps) 314, a return conduit 316 for returning water to the storage tank 302, a pump (e.g., a circulation pump) 318 for circulating the water from the storage tank 302 to the one or more water outlets 314, and one or more thermal valves 100-2. The arrows along the conduits are indicative of the direction of water flow in the recirculation hot water supply system 200.

In an embodiment, the storage tank 302 includes an integrated water heater instead of the separate boiler 304.

In an embodiment, the hot water supply system 300 includes one or more loops 330 having a series of water outlets 314 for user consumption of hot water. In an example, each loop represents a riser in a multi-story building, and each water outlet 314 supplies water to a living unit.

In an example, the water outlets 314 may be shower heads, faucets, etc. In some examples, the return path of each of the loops 330 may be through path P1 and/or through path P2.

In an embodiment, a thermal valve 100-1 may be placed in position A along the return conduit 316, which may be close to the storage tank 302. Position A may be before or after the pump 318 along the return path.

In an embodiment, the heat-sensitive material (e.g., wax) within the thermal valve 100-2 may be selected such that the closing temperature of the thermal valve 100-2 (i.e., the temperature at which the heat-sensitive material inside the thermal valve 100-2 expands and closes the valve 100-2) is about the same as or slightly below a preselected setpoint temperature of the hot water supply system 300. For example, when the preselected setpoint temperature (e.g., the desired temperature at which the hot water is desired to be maintained) is about 110° F., a thermal valve 100-2 having a closing temperature of 105° F. or 110° F. may be employed.

In one illustrative scenario, when demand for hot water is high, the storage tank 302 may not be able to supply enough hot water to satisfy the users' water needs and, as a result, the temperature of the water along the return path (i.e., the return temperature) may drop well below the setpoint temperature. In another illustrative scenario, a loop 330 may be losing more heat than expected (e.g., as a result of cold environmental temperatures, poor insulation, leakage, etc.) causing the temperature along the return path to be below the setpoint temperature. Thus, the return temperature (e.g., the temperature of water along the return conduit 316) may be below the closing temperature of the thermal valve 100-2. In such a case, the heat-sensitive material inside the thermal valve may be in a contracted solid state and the thermal valve 100-2 may be in an open state (e.g., the default state of the thermal valve 100-2) allowing water to freely flow through the return conduit 316 and to the storage tank 302. The boiler 304 heats the water at the storage tank 302 in order to increase the water temperature up to the setpoint temperature.

As the water temperature approaches the setpoint temperature, the water temperature may exceed the closing temperature of thermal valve 100-2, causing the heat-sensitive material therein to expand and close the thermal valve 100-2. When the thermal valve 100-2 closes, the circulation of water in the hot water supply system 300 may cease or may become very small (e.g., as may occur when the thermal valve 100-2 has one or more bypass holes as described above with respect to FIGS. 1A-1B and 2). This may lead to substantial energy savings because circulating less water through the system uses less electrical energy at the circulation pump 318 and less energy at the boiler 304.

In an embodiment, each loop 330 of the hot water supply system 300 includes a thermal valve 100-2. For example, a riser 330 may include a thermal valve 100-2 in position B. As such, in a multi-loop system, the flow of water through each of the loops 330 is separately and passively controlled.

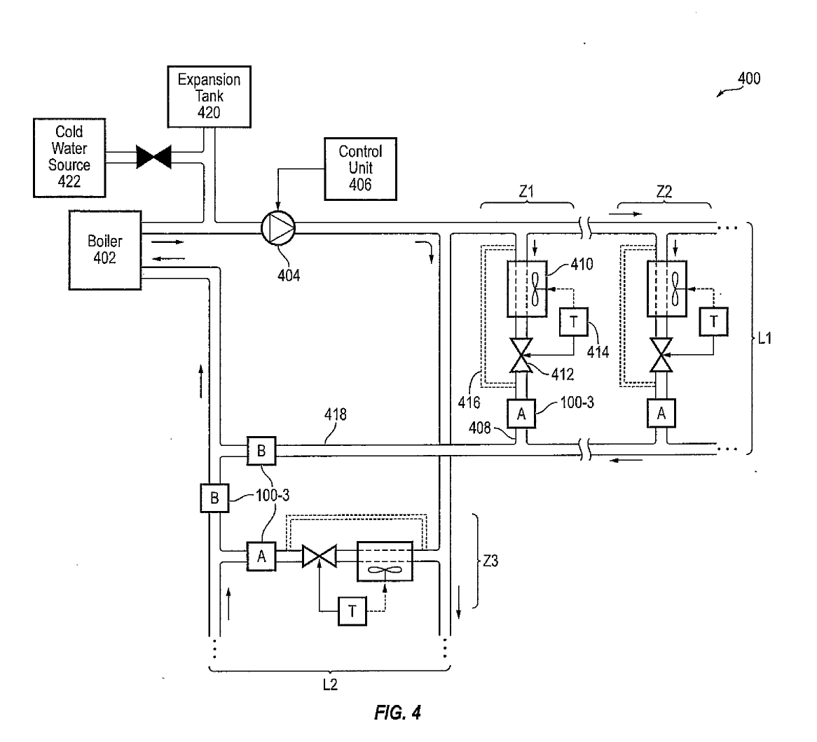

FIG. 4 is a schematic diagram of a hydronic heating system 400 including the thermal valve 100-3, according to an illustrative embodiment of the present invention.

According to an embodiment, the hydronic heating system (e.g., the closed-loop domestic hydronic heating system) 400 includes a boiler 402, a pump (e.g., circulation pump) 404 for pumping a heating fluid (e.g., water) through the system 400, a control unit 406 for controlling the on/off state and/or speed of the pump 404, one or more loops (such as loops A and B), and one or more thermal valves 100-3. A thermal valve 100-3 may be similar in structure to the thermal valve 100 described above with respect to FIGS. 1A and 1B. The arrows along the conduits are indicative of the direction of flow of the heating fluid within the hydronic heating system 400.

Each loop may represent a building or a section of a building and may be divided into a number of zones (such as zones Z1, Z2, and Z3), which may represent, for example, different floors, rooms, and/or offices.

Each zone may include a zone pipe 408 for carrying hot fluid from the boiler 402 to the zone, a terminal unit (e.g., a fan coil, radiator, heat pump, etc.) 408 for extracting thermal energy from the zone pipe 408 and providing heat to the corresponding zone, a zone valve 412 for allowing/stopping the flow of water through the zone pipe 408, and a thermostat 414 for controlling the zone valve 412. In an example, when the thermostat 414 detects that the zone temperature has reached the set point (e.g., 70° F.), the thermostat closes the zone valve 412 to prevent further flow of heating fluid through the zone pipe 408. The thermostat may also control the state (e.g., on/off state) of the terminal unit 410. In an embodiment, each zone may also include a bypass path 416 to allow limited flow of heating fluid through the zone even when the zone valve 412 is closed.

In an embodiment, each zone also includes a thermal valve 100-3 for controlling the flux of heating fluid through the zone based on the temperature of the heating fluid. For example as the temperature of the heating fluid flowing through the zone pipe 408 increases to approach a desired temperature (e.g., 160° F.), the thermal valve 100-3 reduces the flow of heating fluid through the zone pipe 408 and shuts off the flow or substantially reduces the flow (e.g., in an embodiment in which the thermal valve 100-3 has one or more bypass holes) when the fluid temperature reaches the desired point. The thermal valve 100-3 operates passively and independently from the zone valve 412. The thermal valve 100-3 may be positioned at any point along the zone pipe 408, for example, at position A shown in FIG. 4. In an embodiment in which each of the zones has a dedicated thermal valve 100-3 (as shown in FIG. 4), the flow of heating fluid through each of the zones is independently and passively adjusted and, as a result, the loop is automatically and passively balanced.

According to an embodiment, each loop may have a thermal valve 100-3 at a position along the return conduit 418 of the loop (e.g., at position B shown in FIG. 4) in addition to, or in lieu of, the dedicated thermal valves 100-3 at each of the zones in the loop.

In an example, hydronic heating system 400 further includes an expansion tank 420 to accommodate for the expansion of the heating fluid as its temperature rises and to stabilize the fluid pressure in the system. The hydronic heating system 400 may further include a cold water source 422 for compensating any fluid loss (e.g., fluid leakage) through the closed loop system.

What is claimed is:

1. A thermal valve for controlling the flow of a fluid, the thermal valve comprising:
a housing having an inlet and an outlet configured to permitting the flow of the fluid through the interior of the housing;
an actuator comprising heat-sensitive material configured to contract or expand based on the temperature of the fluid;
a shaft configured to couple the actuator to the housing;
a piston partially inside the actuator and configured to move in a lengthwise direction of actuator as the heat-sensitive material contracts or expands; and
a disk coupled to the piston and having a diameter greater than a diameter of the inlet, the disk being configured to reduce a gap between the disk and the inlet as the fluid temperature increases.

2. The thermal valve of claim 1, wherein the disk reduces the gap to zero when the fluid temperature exceeds a setpoint.

3. The thermal valve of claim 2, further comprising a compressive element coupled to the housing and the disk and configured to maintain the disk at a distance from the inlet when the fluid temperature does not exceed the setpoint.

4. The thermal valve of claim 2, further comprising a bypass hole configured to permit the fluid to flow through the housing irrespective of fluid temperature.

5. The thermal valve of claim 1, wherein the heat-sensitive material includes wax.
